(19) United States
(12) Patent Application Publication
(10) Pub. No.: US 2006/0081824 A1
(43) Pub. Date: Apr. 20, 2006

(54) Rapid rotating device for ratchet belt shaft

(76) Inventor: Bu Qin Ruan, Zhejiang (CN)

Correspondence Address: Bergman Kuta LLP;Michael Bergman, P.O. Box 400167, Cambridge, MA, 02144, US

(21) Appl. No.: 10/964,993

(22) Filed: Oct. 14, 2004

(51) Int. Cl. B25B 25/00

(52) U.S. Cl. 254/218

(57) ABSTRACT

A ratchet mechanism for a cargo tie-down including a unidirectional coupling. The unidirectional coupling is adapted to receive a bi-directional torque at an input thereof, and provide a unidirectional torque to a belt shaft at an output thereof.

### FIELD OF THE INVENTION

The present invention relates to a tie-down, and more particularly to a ratchet tie-down.

### BACKGROUND

During the transportation of goods through automobile, the goods will need to be secured to prevent the goods from falling off the automobile, or crashing into one another to induce damage. It is a common practice to tie the goods down with ropes to the bed of trucks, although it may be a time consuming process that requires a lot of effort, and is difficult to secure the goods properly.

A ratchet is an advanced tying tool. Ratchets have been well received among truck drivers due to the ease of use and safety concerns when tying down the goods. As shown in FIG. 5, there is a frame 4 and belt shaft 3 on the ratchet with belt shaft 3 located on the frame 4, and belt shaft can be turned. The tie-down belt is then wrapped around the belt shaft 3, and can be tightened when turning the belt shaft 3, and to retract the belt.

The current method of tying involves turning the belt shaft 3 by using a crowbar to stick through the crowbar hole 9. Due to the fact that the ratchet is attached to the truck bed, it is necessary to remove the crowbar from the crowbar hole 9 after a certain angle of the belt shaft 3 has been turned, and re-insert the crowbar into the crowbar hole at a different angle.

Obviously, it is a slow process, and it takes a lot of effort. In the meantime, it is possible to cause harm to fingers or other body parts due to frequent insertions and removals of crowbar.

### SUMMARY OF THE INVENTION

The present invention resolves many of the issues mentioned above. This invention provides a rapid rotating device such that it will not be necessary to remove and insert crowbar during operation, thus achieving easy, effortless operation, and increase of tie-down speed to ensure safe and reliable operation.

This invention is realized through the following technical solutions: the rapid rotating device for use with the ratchet belt shaft is set up on the side of the belt shaft that is next to the ratchet frame. The characteristics of the rapid rotating device are: the device includes a fixed base and a rotating body, with the fixed base attached firmly to the belt shaft, and the rotating device is fit circumferentially around the fixed base on the side; a unidirectional link-drive mechanism is located at the contacting surface between the fixed base and the rotating, and at least one crowbar hole on the rotating body.

In the aforementioned ratchet belt shaft rapid rotating device, the unidirectional link-drive mechanism includes the several spring holes located at the contacting surface between rotating body and fixed base, with one spring and a push-pin, which will push against the side of the fixed base due to spring force; an equal number and positonally-matched slide grooves will be located on the side of the fixed base, with one side of the slide grooves inclined toward the direction of rotation of the rotating device, and extend to the surface of the fixed base, while the other side will be perpendicular to the side surface of the fixed base.

While turning the rotating body toward the inclined surfaces of the slide grooves during usage, the pushing-pins will slide up against the inclined side of the grooves, and push the pushing-pins into the spring holes until the pushing-pins slide onto the side surface of the fixed base. The pushing-pins will fall into the next slide grooves if the rotating body is turned further, and the whole slide-up-fall-in action of the pushing-pins will be repeated. Obviously, when turning the rotating body in one direction will not drive the belt shaft since the fixed base is not turned by the rotating body.

On the other hand, if turning the rotating body in the reverse direction, the pushing-pins will be stopped by the perpendicular side of the slide grooves after sliding into the grooves and unable to turn further without turning the fixed base, thus resulting in the link-drive relationship between the fixed base and rotating body. Under the turning moment of the rotating body, the fixed base will follow accordingly and thus drive the belt shaft.

When applying the rotating device toward the ratchet, it is necessary to ensure the rotating direction of the link-drive mechanism between fixed base and the rotating body is the same as the tighten direction of the belt shaft. Thus it is only necessary to turn the crowbar back and forth after putting the crowbar into the crowbar hole on the rotating body to tighten the belt. Since the fixed base can only rotate unidirectionally, this back-and-forth motion will be enough to tighten the belt. After the tightening is complete, simply remove the crowbar from the hole.

Compared to the current method of exerting the crowbar directly into the end of the belt shaft, the ratchets utilizing the rapid rotating device possesses benefits such as safe, reliable and effortless operation; no need to remove and re-insert the crowbar, and won't harm the product or the operator. In the meantime, there is no restriction on the latitude of forward and backward motion on the crowbar, which increases the ease of use of the ratchet, and improves the speed of tying, resulting in higher practical value.

### BRIEF DESCRIPTION OF THE DRAWINGS

FIG. 1 is the mechanical schematics of the rapid rotating device for the ratchet;

FIG. 2 is the side-view diagram of the fixed base for the rapid rotating device;

FIG. 3 is the cross-section diagram along A-A line in FIG. 2;

FIG. 4 is the cross section view of the fixed base for the rapid rotating device; and

FIG. 5 is the mechanical schematic of a regular ratchet along the belt shaft.

In the figures, 1: Fixed base; 2. Rotating body; 3: Belt shaft; 4: Supporting frame; 5: Slide groove; 6: Spring hole; 7: Spring; 8: Pushing-pin; 9: Crowbar hole; 10: Locating plate; 11: Screw.

### DETAILED DESCRIPTION OF THE INVENTION

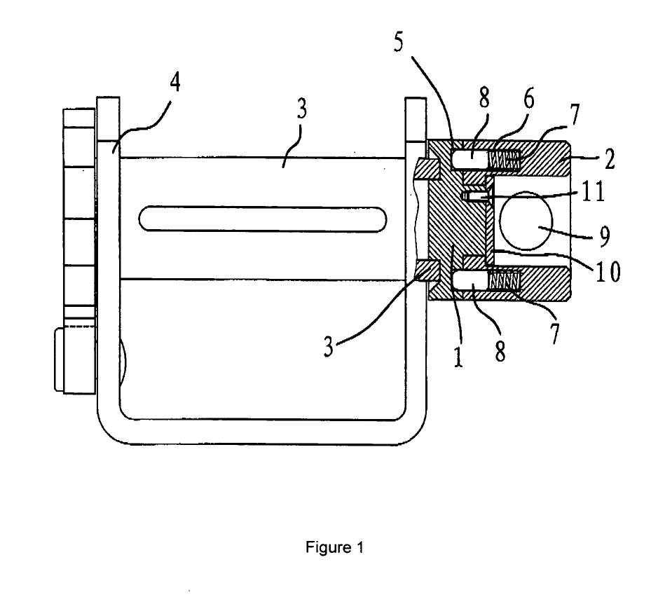

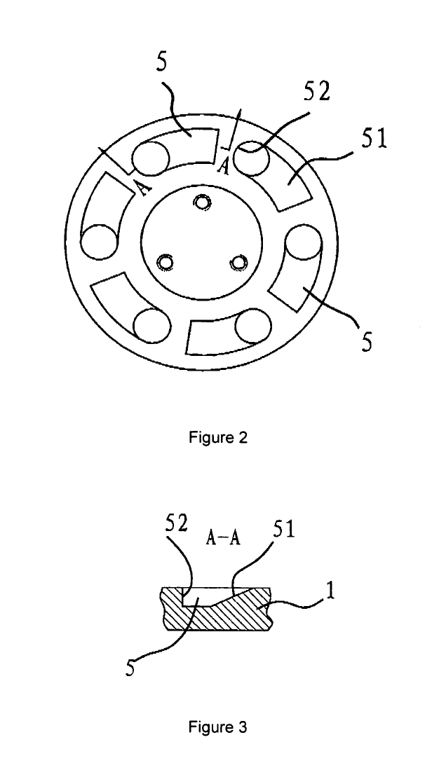

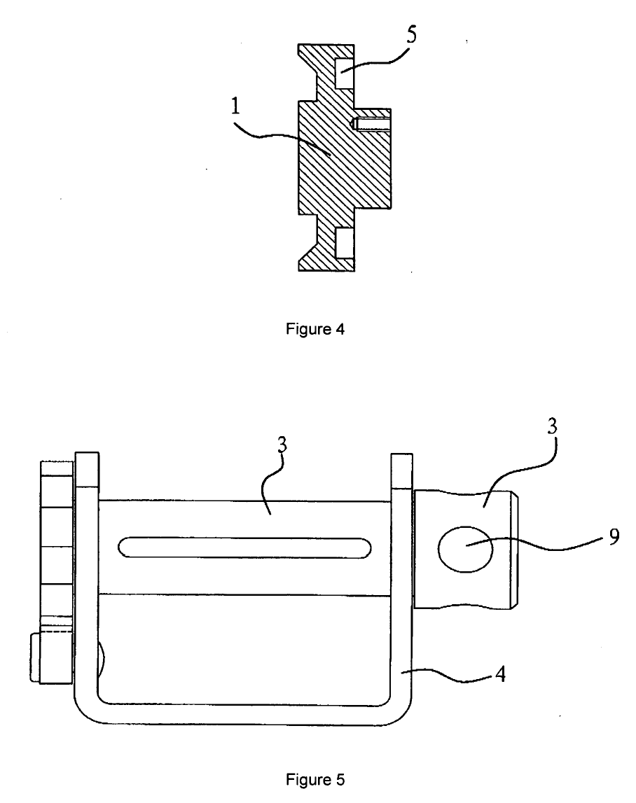

As shown in FIG. 1, the rapid rotating device is set up on the extended part of the belt shaft 3 that is on the side of the ratchet supporting frame 4. The device includes a fixed base 1 and a rotating body 2. Belt shaft 3 can be rotated, and is installed on the ratchet supporting frame 4. When in use, belt shaft 3 will be wrapped with belt. Fixed base 1 is firmly attached to belt shaft 3.

Rotating body 2 is inserted circumferentially along the side of the fixed base 1. In this example, a locating plate 10 is installed between the rotating body 2 and fixed base 1, while rotating body 2 is socketed onto the fixed base 1, and is attached onto the fixed base 1 by means of bolted down by screws 11 over locating plate 10. By adapting mechanisms as above, rotating body 2 is well attached to the fixed base 1, and can be rotated against fixed base 1.

As shown in FIG. 1, there is a crowbar hole on the rotating body 2. A side is perpendicular to the side surface of the fixed base 1 is the straight side 52. Inclined side of the groove 51 is inclined toward the rotating direction of the rotating body 2, and extended to the side surface of the fixed base 1.

As shown in FIG. 1, there are 5 equally spaced spring holes 6 that correspond to the slide grooves 5, each of the holes is inserted a spring 7 and a pushing-pin 8. The size of pushing-pin 8 is a little smaller than the size of slide groove 5, while pushing-pin 8 can be inserted into slide groove 5. When rotating body 2 is rotated to the location where spring hole 6 is mated with slide groove 5, the pushing-pin 8 will be pushed into the slide groove 5 by the acting force of spring 7.

Obviously, if the rotating body 2 is turned in the direction of inclined side of the slide groove, pushing-pin 8 will be pushed up along the inclined face 51 of the slide groove 5, until pushing-pin 8 is blocked by the straight face 52 of the slide groove 5, and unable to slide over slide groove 5. At this time, the rotating body 2 and fixed base 1 will become a link-drive system, thus drive the belt shaft 3.

While turning the rotating body 2 back and forth, it is only possible to turn the fixed base in one direction. Thus if a crowbar is inserted into the crowbar hole 9 and the crowbar is turned up and down, the belt shaft 3 will be turned to tighten the belt.

1. The connection between the ratchet belt shaft and the rapid rotating device will realize the functionality of unidirectional belt shaft rotation driven by the rapid rotation device, while not rotating when rapid rotation device is turned in the other direction.

2. The rapid rotating device includes a fixed base that is connected to the belt shaft of the ratchet, and a rotating body which fits circumferentially around the fixed base on the side, with unidirectional link-drive mechanism. There should be at least one or more holes for crowbar.

3. The unidirectional connecting mechanism includes: several spring holes located at the interface between rotating body and fixed base, for each spring hole a spring and a push-pin, which will act upon the spring force to press against the side of the fixed base. On the side of the fixed base there will be several slide groove that correspond to the locations of the spring holes. One side of the slide groove is shaped as a slope that following the rotating direction of the rotating body, and extend to the surface of the fixed base, whereas the other side will be a vertical surface that is perpendicular to the fixed base.

4. A ratchet mechanism comprising:
a belt shaft;
a ratchet coupled to said belt shaft; and
a uni-directional coupling, said unidirectional coupling having a mechanical output coupled to said belt shaft and a mechanical input, said unidirectional coupling being adapted to receive a bidirectional torque at said mechanical input and produce a unidirectional torque at said mechanical output.

5. A ratchet mechanism as defined in claim 1 further comprising:
a base having at least one bearing surface, said bearing surface being adapted to support said belt shaft.

6. A ratchet mechanism as defined in claim 1 wherein said mechanical input includes at least one aperture adapted to receive a portion of crowbar therewithin.
